(19) United States
(12) Patent Application Publication
(10) Pub. No.: US 2026/0082469 A1
(43) Pub. Date: Mar. 19, 2026

(54) LIGHT SOURCE DRIVING SYSTEMS AND DEVICES

(71) Applicant: O2Micro, Inc., Santa Clara, CA (US)

(72) Inventors: Sheng-Tai LEE, Taipei City (TW); Rong HU, Beijing (CN)

(21) Appl. No.: 19/323,666

(22) Filed: Sep. 9, 2025

(30) Foreign Application Priority Data
Sep. 13, 2024 (CN) 202411287576.0
Jan. 21, 2025 (CN) 202510096095.X

(51) Int. Cl. H05B 45/52; G09G 3/34; H05B 45/34; H05B 45/56

(52) U.S. Cl. CPC H05B 45/52; G09G 3/3406; H05B 45/34; H05B 45/56; G09G 2330/021

(57) ABSTRACT

A light source driving system is configured to drive multiple sets of LEDs sharing common power supply terminal. The light source driving system includes a feedback node and multiple light source driving devices coupled to the feedback node. The feedback node is configured to provide a power-supply adjustment signal to adjust a supply voltage at the power supply terminal. The multiple light source driving devices are configured to generate multiple feedback output signals to control the power-supply adjustment signal in parallel. Each light source driving device of the multiple light source driving devices is configured to drive a set of LEDs of the multiple sets of LEDs, and to generate a feedback output signal of the multiple feedback output signals based on power supply status of the set of LEDs.

### RELATED APPLICATIONS

This application claims benefit under 35 U.S.C. § 119(a) to Application No. 202510096095.X, filed with the State Intellectual Property Office of the People's Republic of China on Jan. 21, 2025, and Application No. 202411287576.0, filed with the State Intellectual Property Office of the People's Republic of China on Sep. 13, 2024, which are hereby incorporated by reference in their entirety.

### BACKGROUND

FIG. 1 illustrates a block diagram of a conventional active-matrix light source driving system 100 for backlight applications. As shown in FIG. 1, the light source driving system 100 includes a power converter 102, a controller 104, and multiple light source driving devices 106_1 to 106_n (where n is a natural number). The power converter 102 generates a supply voltage V_{LED} to power a light source 108 that includes multiple sets of light-emitting diode (LED) strings. The light source driving devices 106_1 to 106_n respectively drive the LED strings S11 to S14, S21 to S24, . . . , and Sn1 to Sn4 in the light source 108, and adjust a current I_{LED} of each LED string to its respective target current level I_{LED_TARGET}. The controller 104 provides the light source driving devices 106_1 to 106_n with information for the target current value I_{LED_TARGET}. The controller 104 can search a lookup table LT(V_{LED_TARGET}, I_{LED_TARGET}) for a target voltage value V_{LED_TARGET} corresponding to the target current value I_{LED_TARGET} and provide the information for the target voltage value V_{LED_TARGET} to the power converter 102. The power converter 102 regulates the supply voltage V_{LED} to the target voltage level V_{LED_TARGET}.

However, in practical situations, the target voltage value V_{LED_TARGET} stored in the lookup table may exceed the actual supply voltage required by the light source 108. This is because the necessary supply voltage varies with the light source's temperature to maintain the LED current I_{LED} at the target current level I_{LED_TARGET}. To ensure that the light source 108 receives a sufficient supply voltage across its normal operating temperature range (e.g., −25° C. to 85° C.), the target voltage value V_{LED_TARGET} is typically set to the maximum supply voltage required by the light source 108 within this range. For example: at −25° C., the light source 108 requires a supply voltage V_{LED} of at least 40V to regulate the current I_{LED} to I_{LED_TARGET}; at 85° C., it requires a supply voltage V_{LED} of at least 30V; and at 20° C., it requires a supply voltage V_{LED} of at least 35V. In this example, the target voltage value V_{LED_TARGET} is set to 40V or higher. This leads to excessive power consumption, reduced efficiency, and unnecessary energy waste.

A conventional solution involves the controller 104 reading data from the driving devices 106_1 to 106_n, performing calculations based on the data, and controlling the power converter 102 to adjust the supply voltage V_{LED} based on the calculation result. However, this approach requires the driving devices 106_1 to 106_n to interface with a dedicated controller or processor (e.g., a microcontroller unit, MCU), which may limit system compatibility and flexibility. Additionally, a dedicated MCU can be relatively expensive and can consume significant power.

Moreover, in large-area backlighting applications, a large number of LED strings is required, and therefore a larger number of light source driving devices is also required. In the conventional light source driving system 100, one controller 104 manages a single chain of light source driving devices 106_1 to 106_n. If the system includes multiple chains of light source driving devices, then multiple controllers are used to manage the multiple chains of light source driving devices respectively. This can further increase the system cost.

Furthermore, in certain scenarios—such as when a display operates in High Dynamic Range mode (HDR mode)—some areas of the display (e.g., referred to as “region 1”) need to be brighter than other areas (e.g., referred to as “region 2”). In other words, the currents flowing through the LEDs in region 1 are greater than those in region 2. This may cause the driving devices for region 1 to operate at higher temperatures than those for region 2. Since conventional light source driving devices incorporate built-in thermal protection, when a driving device detects that its temperature exceeds a protection threshold, it automatically shuts down, cutting off power to its corresponding LED strings. This can result in dark patches/spots on the display, which can severely degrade visual performance.

### SUMMARY

Embodiments of the present invention provide solutions to the problems described above.

In an embodiment, a light source driving system is configured to drive multiple sets of LEDs sharing a common power supply terminal. The light source driving system includes a feedback node and multiple light source driving devices coupled to the feedback node. The feedback node is configured to provide a power-supply adjustment signal to adjust a supply voltage at the power supply terminal. The multiple light source driving devices are configured to generate multiple feedback output signals to control the power-supply adjustment signal in parallel. Each light source driving device of the multiple light source driving devices is configured to drive a set of LEDs of the multiple sets of LEDs, and to generate a feedback output signal of the multiple feedback output signals based on a power supply status of the set of LEDs.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates a block diagram of a conventional light source driving system.

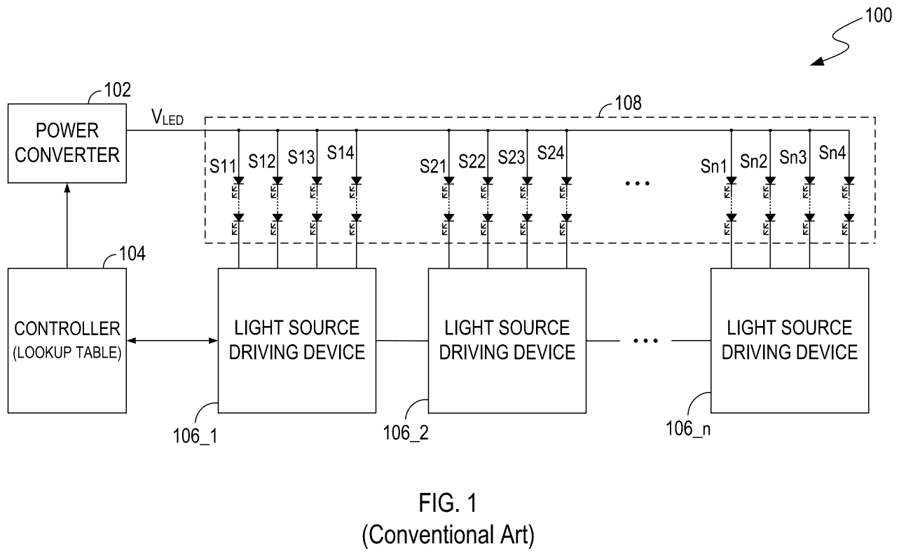

FIG. 2A illustrates a block diagram of an example of a light source driving system, in an embodiment of the present invention.

FIG. 2B illustrates a block diagram of an example of a light source driving system, in an embodiment of the present invention.

FIG. 2C illustrates a block diagram of an example of a light source driving system, in an embodiment of the present invention.

FIG. 3A illustrates a block diagram of an example of a light source driving device, in an embodiment of the present invention.

FIG. 3B illustrates a block diagram of an example of a light source driving device, in an embodiment of the present invention.

FIG. 4 illustrates a circuit diagram of examples of comparator circuitry and a power-supply adjustment module, in an embodiment of the present invention.

FIG. 5A illustrates a block diagram of an example of a light source driving system, in an embodiment of the present invention.

FIG. 5B illustrates a block diagram of an example of a light source driving system, in an embodiment of the present invention.

FIG. 6A illustrates a block diagram of an example of a light source driving device, in an embodiment of the present invention.

FIG. 6B illustrates a block diagram of an example of a light source driving device, in an embodiment of the present invention.

FIG. 6C illustrates a circuit diagram of examples of comparator circuitry and a power-supply adjustment module, in an embodiment of the present invention.

FIG. 7 illustrates a block diagram of an example of a light source driving system, in an embodiment of the present invention.

FIG. 8A illustrates a block diagram of an example of a light source driving device, in an embodiment of the present invention.

FIG. 8B illustrates a circuit diagram of examples of comparator circuitry and a power-supply adjustment module, in an embodiment of the present invention.

FIG. 8C illustrates a circuit diagram of examples of comparator circuitry and a power-supply adjustment module, in an embodiment of the present invention.

FIG. 9 illustrates a block diagram of an example of a light source driving system, in an embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications, and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments according to the present invention provide light source driving systems with an active-matrix structure. The light source driving system can be used to drive light-emitting diodes (LEDs) in a display backlight. More specifically, the backlight may include multiple sets of LEDs, each set including multiple LED strings, and each string including one or more LEDs. In an embodiment of the present invention, the light source driving system includes multiple light source driving devices (or multiple chains of light source driving devices). Each of the driving devices can drive a set of LEDs. The multiple light source driving devices (or multiple chains of light source driving devices) can perform parallel regulation of the power supply voltage for the backlight based on the real-time power supply status of the backlight. Compared to the conventional light source driving system 100, the light source driving system in an embodiment of the present invention can avoid power wastage caused by using a lookup table to determine the light source supply voltage, and can reduce power consumption, improve operational efficiency, and enhance the speed of regulating the backlight's supply voltage. Additionally, in some embodiments of the present invention, the light source driving system can dynamically adjust the supply voltage based on the real-time power demand of the backlight without requiring a dedicated controller or processor (e.g., an MCU), thereby reducing system costs and further lowering power consumption. Test results show that, compared to some existing light source driving systems, the performance-per-watt ratio of the light source driving system in an embodiment of the present invention can be improved by 5% to 10%.

Furthermore, in some embodiments of the present invention, each of the light source driving devices can operate in a voltage feedback mode or a current feedback mode, depending on its application condition. For example, in a chain of light source driving devices (e.g., multiple devices connected in sequence), a light source driving device can operate in the voltage feedback mode, where it provides a feedback voltage to the next adjacently coupled device. For light source driving devices coupled to a power source of the backlight but belonging to different chains, the devices can operate in the current feedback mode, generating multiple feedback currents to control the power source in parallel. Compared to conventional light source driving systems, a system using the light source driving devices according to embodiments of the present invention can reduce costs and more quickly adjust all LEDs in the backlight.

Additionally, in some embodiments of the present invention, the light source driving device can perform a thermal foldback function in addition to temperature protection. Specifically, the temperature protection function refers to the automatic shutdown of the light source driving device when its temperature exceeds a temperature protection threshold. The thermal foldback function can be enabled or disabled. When it is enabled, if the light source driving device detects that its temperature exceeds a thermal foldback threshold (e.g., a first temperature threshold), it can reduce the LED driving current to lower the temperature. The light source driving device may decrease the LED driving current step by step until the temperature drops below a second temperature threshold. The second temperature threshold is lower than the first temperature threshold, and the first temperature threshold is lower than the temperature protection threshold. Thus, displays driven by the light source driving devices according to embodiments of the present invention can avoid dark patches/spots caused by excessive temperatures.

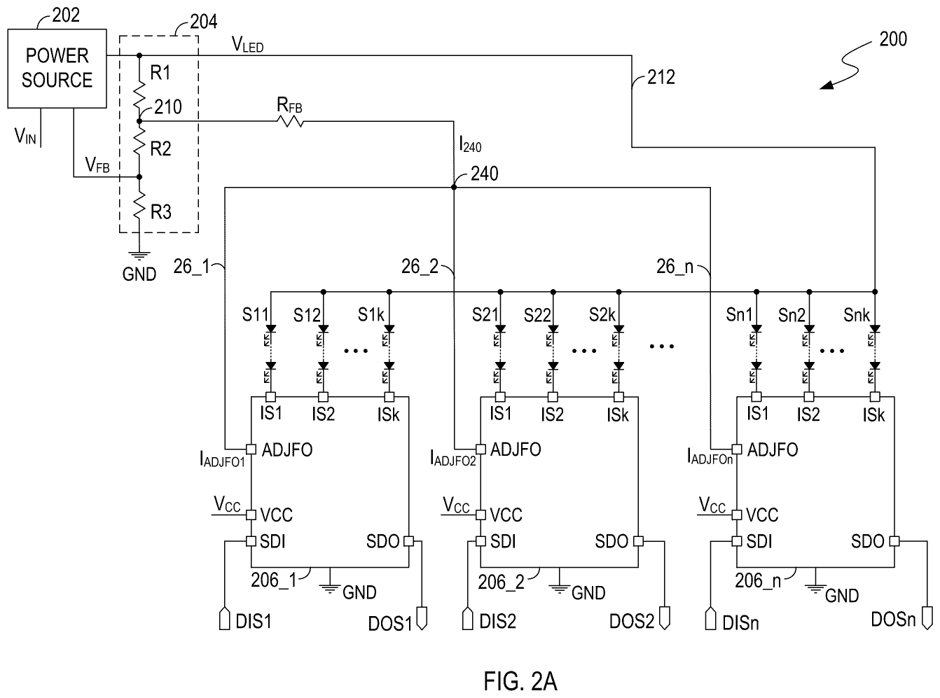

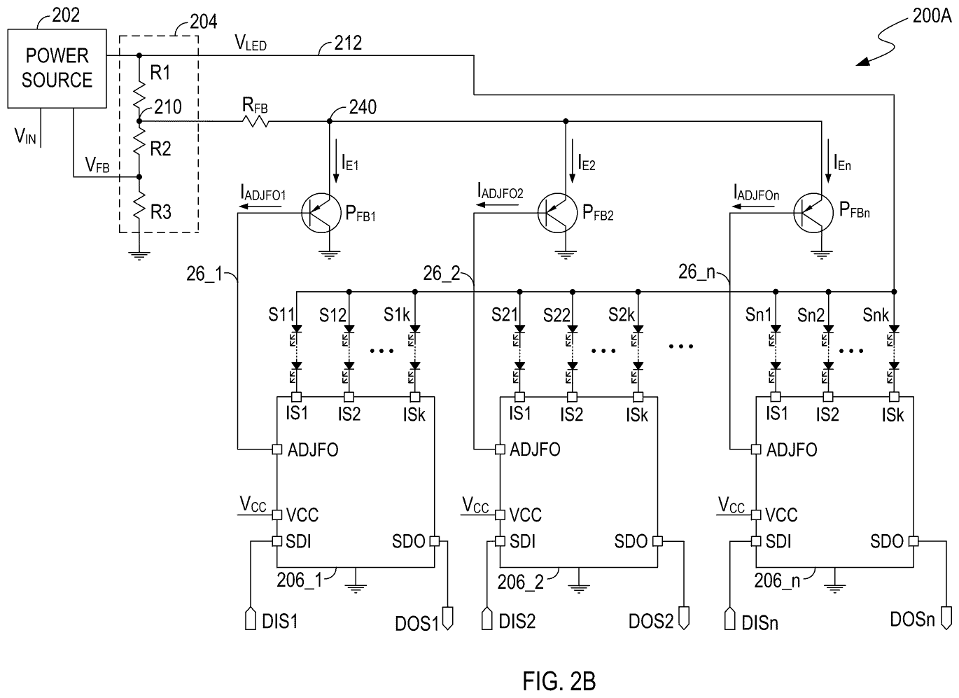

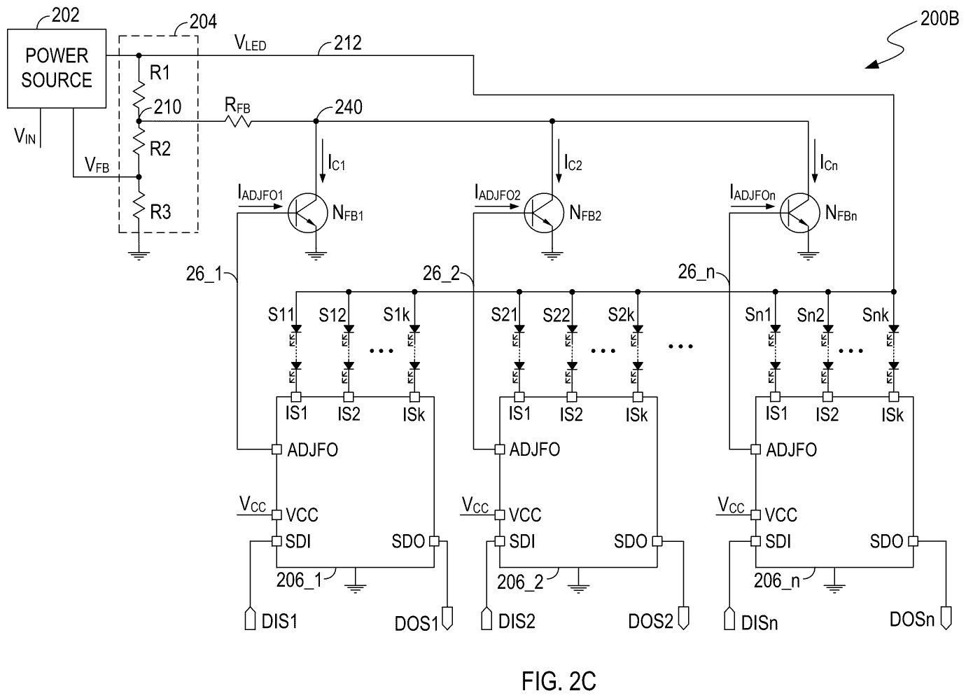

FIG. 2A illustrates a block diagram of an example of a light source driving system 200, in an embodiment of the present invention. The light source driving system 200 can drive multiple sets of LEDs S11 to S1k, S21 to S2k, . . . , and Sn1 to Snk sharing a common power supply terminal 212, where k and n are natural numbers. The LEDs S11-S1k, S21-S2k, . . . , Sn1-Snk include n sets of LEDs, each set includes k strings of LEDs, and each string includes one or more LEDs. In some embodiments, a single string of LEDs can also be referred to as a set of LEDs.

As shown in FIG. 2A, the light source driving system 200 includes a power source 202 (e.g., a DC/DC converter, an AC/DC converter, or the like), a feedback circuit 204, and multiple light source driving devices 206_1 to 206_n. Each light source driving device 206_1-206_n is configured to drive a respective set of LEDs. For example, the device 206_1 drives LEDs S11-S1k, the device 206_2 drives LEDs S21-S2k, and so on.

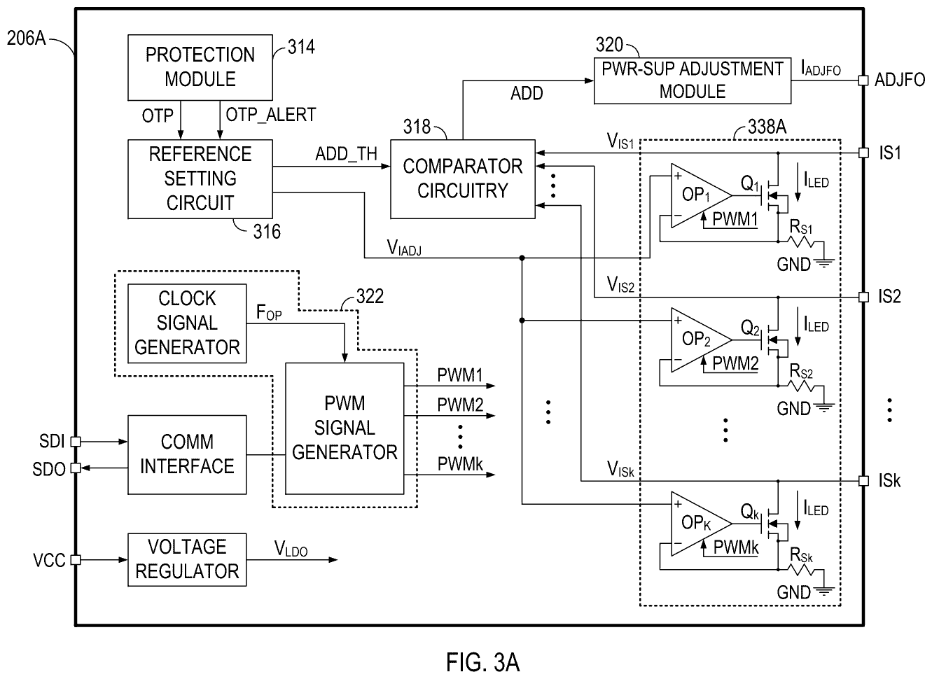

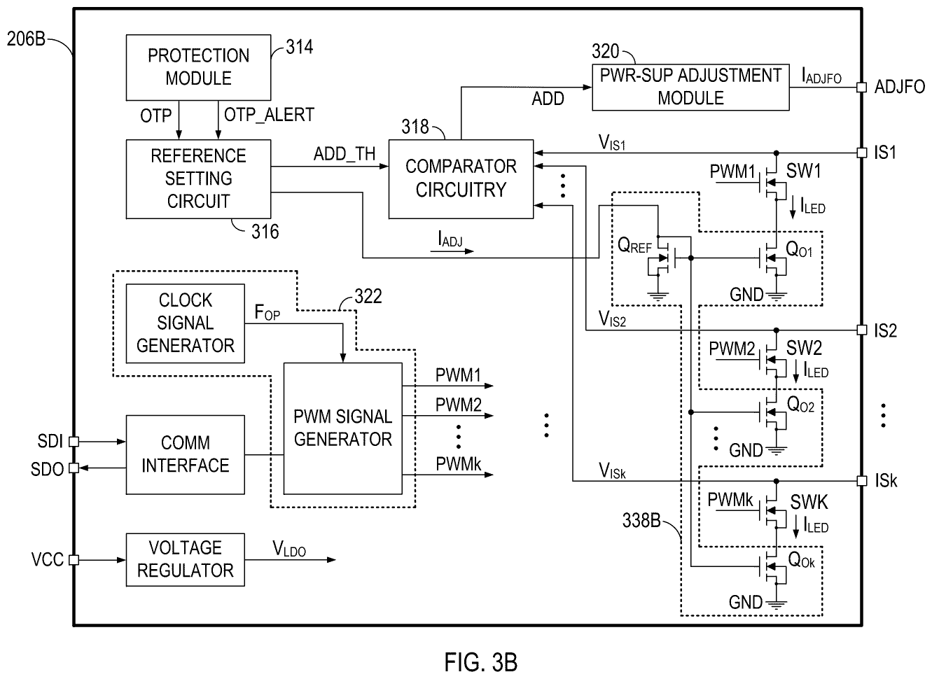

The light source driving devices 206_1-206_n are coupled to a feedback node 240 and generate multiple feedback output signals 26_1-26_n to parallelly control a power regulation signal at the feedback node 240. More specifically, each device 206_1-206_n includes multiple sensing terminals IS1 to ISk, and each sensing terminal is configured to sense a voltage at a cathode of a corresponding LED string (or a corresponding set of LEDs) to determine its power supply status. For example, the sensing terminal IS1 of the device 206_1 is coupled to the cathode of the LED string S11 to sense a voltage at that cathode, the sensing terminal IS2 is coupled to the cathode of the string S12 to sense a voltage at that cathode, and so on. In an embodiment, the cathode voltage of each LED string indicates the LED string's power supply status or current status. For instance, if an LED string is underpowered, its cathode voltage is below a specific threshold, and its driving current cannot be adjusted to a target level. If the cathode voltage exceeds the threshold, it indicates that the LED string is sufficiently powered, and its driving current can be adjusted to the target level. In an embodiment, the light source driving device 206_1 compares the voltages at the sensing terminals IS1 to ISk with a preset voltage ADD_TH (e.g., the voltage ADD_TH shown in FIG. 3A). The preset voltage ADD_TH can be set equal to or slightly greater than the aforementioned threshold. When the voltage at the sensing terminal IS1 is greater than the preset voltage ADD_TH, the LED string S11 is considered to be in a power-sufficient state. When the voltage is less than the preset voltage ADD_TH, the LED string S11 is considered to be in a power-increasable state. If all the voltages at the sensing terminals IS1 to ISk are greater than the preset voltage ADD_TH, then the set of LEDs S11-S1k can be considered to be in the power-sufficient state. If one or more of the voltages at the sensing terminals IS1 to ISk are less than the preset voltage ADD_TH, the set of LEDs S11-S1k can be considered to be in the power-increasable state. The light source driving device 206_1 can generate a feedback output signal 26_1 based on a power supply status of the set of LEDs S11-S1k. In the example of FIG. 2A, the feedback output signal 26_1 includes a feedback output current I_{ADJFO1}. Similarly, the light source driving devices 206_2-206_n can generate respective feedback output signals 26_2-26_n (e.g., including feedback output currents I_{ADJFO2} to I_{ADJFOn}) based on the power supply statuses of their corresponding sets of LEDs. The light source driving devices 206_1-206_n can generate the feedback output signals 26_1-26_n in parallel (e.g., concurrently, and/or along side-by-side paths that meet at the feedback node 240), thereby controlling a power-supply adjustment signal (e.g., a current signal I₂₄₀) at the feedback node 240. In the example of FIG. 2A, the power-supply adjustment current I₂₄₀ includes the sum of the feedback output currents I_{ADJFO1} to I_{ADJFOn}. Thus, the feedback output signals 26_1-26_n can control the power-supply adjustment signal I₂₄₀ in parallel.

The feedback node 240 is configured to provide the power-supply adjustment current I₂₄₀ to adjust the supply voltage V_{LED} generated by the power source 202 at the power-supply terminal 212. More specifically, the light source driving system 200 includes a feedback circuit 204, coupled between the power supply terminal 212 and the feedback node 240, and configured to generate a power-supply feedback signal V_{FB} based on the supply voltage V_{LED} and the power-supply adjustment signal I₂₄₀. The power source 202 can regulate the power-supply feedback signal V_{FB} to a power-supply reference V_{REF}, thereby adjusting the supply voltage V_{LED} such that all the LED sets S11-S1k, S21-S2k, . . . , Sn1-Snk operate in the power-sufficient state.

By way of example, the feedback circuit 204 can include a voltage divider. In the example of FIG. 2A, the feedback circuit 204 includes resistors R1, R2, and R3. The power-supply feedback signal V_{FB} can be given by: V_{FB}=V_{LED}*R3/(R1+R2+R3)+f(I₂₄₀), where f(I₂₄₀) represents a function of the power-supply adjustment current I₂₄₀. More specifically, in an embodiment, each of the feedback output currents I_{ADJFO1} to I_{ADJFOn} includes a sink current flowing from the feedback node 240 into a corresponding light source driving device 206_1-206_n. Therefore, the power-supply adjustment current I₂₄₀ flows out from the connection node 210 of the resistors R1 and R2, the value of f(I₂₄₀) is negative, and an increase in the power-supply adjustment current I₂₄₀ can reduce the power-supply feedback signal V_{FB}. If one or more strings of the LED strings S11-S1k, S21-S2k, . . . , and Sn1-Snk are in the power-increasable state, then the corresponding light source driving device 206_1-206_n can increase its corresponding sink current I_{ADJFO1}, I_{ADJFO2}, . . . , or I_{ADJFOn}, thereby increasing the power-supply adjustment current I₂₄₀, and thus reducing the power power-supply feedback signal V_{FB}. The power source 202 can compare the feedback signal V_{FB} with a power-supply reference V_{REF}, reduce the supply voltage V_{LED} if the feedback signal V_{FB} is greater than the reference V_{REF}, and increase the supply voltage V_{LED} if the feedback signal V_{FB} is less than the reference V_{REF}. Thus, the feedback signal V_{FB} can be regulated to the power-supply reference V_{REF}. As a result, the supply voltage V_{LED} is adjusted such that all the LED strings S11-S1k, S21-S2k, . . . , Sn1-Snk operate in the power-sufficient state. In an alternative embodiment, each of the feedback output currents I_{ADJFO1} to I_{ADJFOn} includes a source current flowing from a corresponding light source driving device 206_1-206_n to the feedback node 240. Therefore, the power-supply adjustment current I₂₄₀ flows into the connection node 210 of the resistors R1 and R2, the value of f(I₂₄₀) is positive, and a decrease in the power-supply adjustment current I₂₄₀ can reduce the power-supply feedback signal V_{FB}. If one or more strings of the LED strings S11-S1k, S21-S2k, . . . , Sn1-Snk are in the power-increasable state, then the corresponding light source driving device 206_1-206_n can reduce its corresponding source current I_{ADJFO1}, I_{ADJFO2}, . . . , or I_{ADJFOn}, thereby reducing the power-supply adjustment current I₂₄₀, and thus reducing the power power-supply feedback signal V_{FB}. Similarly, by regulating the feedback signal V_{FB} to the power-supply reference V_{REF}, the power source 202 can control the supply voltage V_{LED} so that all the LED strings S11-S1k, S21-S2k, . . . , Sn1-Snk operate in the power-sufficient state.

Although FIG. 2A shows the feedback circuit 204 includes resistors R1, R2, and R3 connected in series, the invention is not limited to this. In other embodiments, the feedback circuit 204 can include other types of circuit configurations, such as two resistors connected in series, multiple resistors connected in a combination of series and parallel, and so on.

FIG. 2B illustrates a block diagram of an example of a light source driving system 200A, in an embodiment of the present invention. FIG. 2B is described in combination with FIG. 2A. The system 200A is similar to the system 200 except that the light source driving devices 206_1-206_n in the system 200A are coupled to the feedback node 240 via PNP bipolar junction transistors P_{FB1} to P_{FBn}. In the example of FIG. 2B, the feedback output signals 26_1-26_n include sink currents I_{ADJFO1} to I_{ADJFOn} flowing into the light source driving devices 206_1-206_n, respectively. The sink currents I_{ADJFO1} to I_{ADJFOn} can serve as the base currents of the transistors P_{FB1} to P_{FBn}, respectively controlling the emitter currents I_{E1} to I_{En} of the transistors P_{FB1} to P_{FBn}. More specifically, an emitter current of a bipolar junction transistor (BJT) is proportional to a base current of the BJT. The power-supply adjustment current I₂₄₀ can include the sum of the emitter currents I_{E1} to I_{En}. Thus, the light source driving devices 206_1-206_n can control the power-supply adjustment signal I₂₄₀ at the feedback node 240 in parallel.

FIG. 2C illustrates a block diagram of an example of a light source driving system 200B, in an embodiment of the present invention. FIG. 2C is described in combination with FIG. 2A and FIG. 2B. The system 200B is similar to the system 200 except that the light source driving devices 206_1-206_n in the system 200B are coupled to the feedback node 240 via NPN BJTs N_{FB1} to N_{FBn}. In the example of FIG. 2C, the feedback output signals 26_1-26_n include source currents I_{ADJFO1} to I_{ADJFOn} flowing out of the light source driving devices 206_1-206_n, respectively. The source currents I_{ADJFO1} to I_{ADJFOn} can serve as the base currents of the transistors N_{FB1} to N_{FBn}, respectively controlling the collector currents I_{C1} to I_{Cn} pf the transistors N_{FB1} to N_{FBn}. More specifically, a collector current of a BJT is proportional to a base current of the BJT. The power-supply adjustment current I₂₄₀ can include the sum of the collector currents I_{C1} to I_{Cn}. Thus, the light source driving devices 206_1-206_n can control the power-supply adjustment signal I₂₄₀ at the feedback node 240 in parallel.

FIG. 3A illustrates a block diagram of an example of a light source driving device 206A, in an embodiment of the present invention. The light source driving device 206A can be an embodiment of one of the aforementioned light source driving devices 206_1-206_n. FIG. 3A is described in combination with FIG. 2A, FIG. 2B, and FIG. 2C. As shown in FIG. 3A, the light source driving device 206A includes a protection module 314, a reference setting circuit 316, comparator circuitry 318, a power-supply adjustment module 320, a signal generation circuit 322, and a current driving circuit 338A.

In an embodiment, multiple LED strings (e.g., those shown in FIGS. 2A-2D) driven by the light source driving device 206A are coupled to a reference ground GND via transistors Q₁ to Qₖ (e.g., MOSFETs) and sensing resistors R_{S1} to R_{Sk}, respectively. For example, an LED string corresponding to the sensing terminal IS1 is coupled to the reference ground GND via the transistor Q₁ and the sensing resistor R_{S1}, an LED string corresponding to the sensing terminal IS2 is coupled to the reference ground GND via the transistor Q₂ and the sensing resistor R_{S2}, and so on. Operational amplifiers OP₁ to OPₖ are coupled to the transistors Q₁ to Qₖ respectively. The operational amplifiers OP₁ to OPₖ (e.g., ideal operational amplifiers) can receive a current-regulation signal V_{IADJ} (e.g., a voltage signal) and apply the current-regulation signal V_{IADJ} to respective sensing resistors R_{S1} to R_{Sk} by controlling their respective transistors Q₁ to Qₖ, thereby regulating the maximum instantaneous value of the driving currents I_{LED} of the LED strings to a target value. The maximum instantaneous value refers to the maximum value of an instantaneous driving current I_{LED} flowing through an LED string when a corresponding transistor Q₁, Q₂, . . . , or Qₖ is turned on. For example, when the LED string coupled to the sensing terminal IS1 is sufficiently powered, the operational amplifier OP₁ can control the transistor Q₁ such that a voltage across the resistor R_{S1} is equal to (or approximately equal to in real-world situations due to non-ideal circuit components) the voltage value of the current-regulation signal V_{IADJ}. When the LED string coupled to the sensing terminal IS1 is underpowered, the voltage across the resistor R_{S1} is less than the voltage value V_{IADJ}. Thus, the maximum instantaneous value of the driving current I_{LED} of the LED string coupled to the sensing terminal IS1 can be V_{IADJ}/R_{S1}. Similarly, the maximum instantaneous value of the driving current I_{LED} of the LED string coupled to the sensing terminal IS2 can be V_{IADJ}/R_{S2}, and so on. In some embodiments, the transistors Q₁ to Qₖ can be referred to as current-regulation components. The light source driving device 206A can sense voltages V_{IS1} to V_{ISk} at the current-regulation components Q₁ to Qₖ (e.g., drain voltages of MOSFETs Q₁ to Qₖ) to determine the power supply status of the LEDs driven by the light source driving device 206A. The voltages V_{IS1} to V_{ISk} can be referred to as sensing voltages V_{IS1} to V_{ISk}.

The signal generation circuit 322 (e.g., including a pulse-width modulation signal generator) can generate pulse-width modulation signals PWM1 to PWMk to enable and disable the operational amplifiers OP₁ to OPₖ, and control the duty cycles of the signals PWM1 to PWMk to control respective average levels of the driving currents I_{LED} through the LED strings. For example, the signal PWM1 can enable and disable the operational amplifier OP1, and its duty cycle can control the average level of the driving current I_{LED} of the LED string coupled to the sensing terminal IS1; the signal PWM2 can enable and disable the operational amplifier OP₂, and its duty cycle can control the average level of the driving current I_{LED} of the LED string coupled to the sensing terminal IS2; and so on. PWM signal generators are known in the art.

In an embodiment, if the sensing voltage V_{IS1} is too low (e.g., due to insufficient supply voltage V_{LED}), then the maximum instantaneous value of the driving current I_{LED} of the LED string coupled to the sensing terminal IS1 cannot be regulated to the target value, indicating that the LED string is underpowered. If the light source driving device 206A detects that one or more of the sensing voltages V_{IS1} to V_{ISk} are too low, then the light source driving device 206A can control a feedback output signal (e.g., I_{ADJFO}) to increase the supply voltage V_{LED}, thereby increasing the sensing voltages V_{IS1} to V_{ISk}.

More specifically, in an embodiment, the comparator circuitry 318 compares the sensing voltages V_{IS1} to V_{ISk} with a preset voltage ADD_TH and provides a comparison result to the power-supply adjustment module 320. The power-supply adjustment module 320 can generate a feedback output signal (e.g., I_{ADJFO}) at a feedback output terminal ADJFO, and includes circuitry configured to adjust the feedback output signal based on the comparison result, thereby adjusting the sensing voltages V_{IS1} to V_{ISk} to be greater than or equal to the preset voltage ADD_TH.

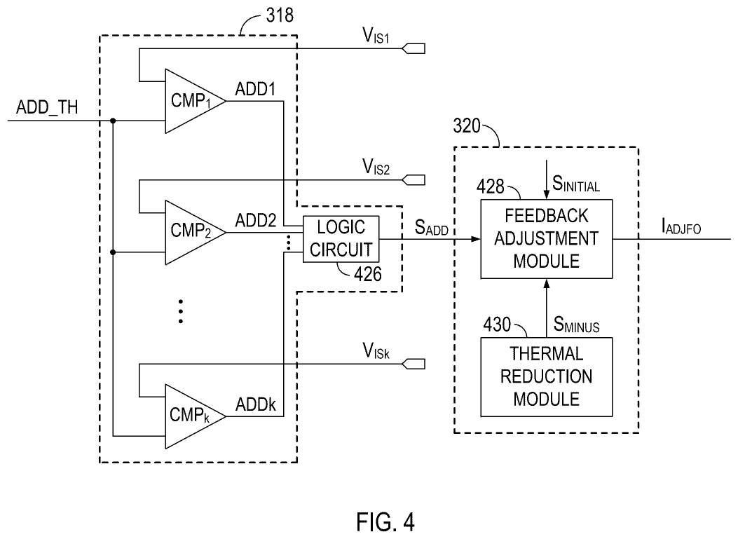

In an embodiment, the comparator circuitry 318 repeats the comparison operation at a specific frequency F1. Each time the comparator circuitry 318 detects that one or more of the sensing voltages V_{IS1} to V_{ISk} are less than the preset voltage ADD_TH, the comparator circuitry 318 generates an increment signal ADD (e.g., a digital signal “1” or “0”). If one or more of the sensing voltages V_{IS1} to V_{ISk} remain less than the preset voltage ADD_TH, then the comparator circuitry 318 can repeatedly generate the increment signal ADD. Each time the increment signal ADD is detected, the power-supply adjustment module 320 changes (e.g., increases or decreases) the feedback output current I_{ADJFO} by a predetermined amount ΔI1 (see also the discussion below of FIG. 4), thereby controlling the power source 202 to increase the supply voltage V_{LED}. When all the sensing voltages V_{IS1} to V_{ISk} are greater than or equal to the preset voltage ADD_TH, the comparator circuitry 318 stops generating the increment signal ADD. When no increment signal ADD is detected, the power-supply adjustment module 320 can repeatedly change (e.g., decrease or increase) the feedback output current I_{ADJFO} by a predetermined amount ΔI2 at a frequency F2 to reduce the supply voltage V_{LED} until the increment signal ADD is detected again (see also the discussion below of FIG. 4). Thus, the power-supply adjustment module 320 can maintain the sensing voltages V_{IS1} to V_{ISk} around the preset voltage ADD_TH while reducing power consumption and lowering the temperature of the light source driving device 206A.

In an embodiment, the light source driving device 206A also includes a clock signal generator (e.g., a high-frequency oscillator) that generates a clock signal for controlling an operating frequency F_{OP} of the light source driving device 206A. In some embodiments, the signals PWM1 to PWMk can be generated based on the operating frequency F_{OP}. For example, the frequencies of the signals PWM1 to PWMk can be equal to or multiples of the operating frequency F_{OP}. Similarly, the aforementioned frequencies F1 and/or F2 can be equal to or multiples of the operating frequency F_{OP}.

In an embodiment, the reference setting circuit 316 includes circuity that can generate the preset voltage ADD_TH. The circuitry of the reference setting circuit 316 can also generate the aforementioned current-regulation signal V_{IADJ} to regulate the maximum instantaneous value of the driving current I_{LED} for each LED string driven by the light source driving device 206A. The protection module 314 includes circuitry that can measure and monitor the temperature TEM₂₀₆ of the light source driving device 206A to prevent the light source driving device 206A from overheating. For example, when the protection module 314 detects that the temperature TEM₂₀₆ exceeds an over-temperature threshold T_{OV}, it can generate a temperature protection signal OTP. In response to the temperature protection signal OTP, the light source driving device 206A can cut off power to the LED strings. Additionally, the protection module 314 can implement a thermal foldback function. When the thermal foldback function is enabled, if the protection module 314 detects that the temperature TEM₂₀₆ exceeds a first temperature threshold T_{THF1}, the protection module 314 can generate a warning signal OTP_ALERT. In response to the warning signal OTP_ALERT, the reference setting circuit 316 can reduce (e.g., stepwise) the preset voltage ADD_TH and the current-regulation signal V_{IADJ} to lower the temperature TEM₂₀₆. When the temperature TEM₂₀₆ decreases to a second temperature threshold T_{THF2}, the reference setting circuit 316 can maintain the preset voltage ADD_TH and the current-regulation signal V_{IADJ} unchanged. The second temperature threshold T_{THF2} is less than the first temperature threshold T_{THF1}, and the first temperature threshold T_{THF1} is less than the over-temperature threshold T_{OV}. By performing the thermal foldback function, a display driven by the light source driving devices according to an embodiment of the present invention can avoid dark patches/spots caused by excessive temperatures. As used herein, “the reference setting circuit 316 can maintain the preset voltage ADD_TH and the current-regulation signal V_{IADJ} unchanged” means that the reference setting circuit 316 neither increases nor decreases the signals ADD_TH and V_{IADJ}. However, in practical situations, the signals ADD_TH and V_{IADJ} may vary slightly over time due to non-ideal circuit components and environmental factors.

Although the current driving circuit 338A in the example of FIG. 3A includes multiple operational amplifiers OP₁ to OPₖ, the invention is not limited. In other embodiments, the current driving circuit can include other circuit configurations. For example, FIG. 3B illustrates a block diagram of an example of a light source driving device 206B, in another embodiment of the present invention. The light source driving device 206B can be an embodiment of one of the aforementioned light source driving devices 206_1-206_n. FIG. 3B is described in combination with FIG. 2A, FIG. 2B, FIG, 2C, and FIG. 3A.

The device 206B in FIG. 3B is similar to the device 206A in FIG. 3A except that the current driving circuit 338B in the device 206B includes a current mirror. Additionally, the light source driving device 206B includes driving switches SW1 to SWk respectively coupled between the sensing terminals IS1-ISk and the current mirror 338B. More specifically, as shown in FIG. 3B, the switch SW1 coupled to the sensing terminal IS1 can enable or disable a driving current I_{LED} through the sensing terminal IS1, the switch SW2 coupled to the sensing terminal IS2 can enable or disable a driving current I_{LED} through the sensing terminal IS2, and so on. The current mirror 338B includes a reference path (e.g., the current path through the transistor Q_{REF}) and multiple output paths (e.g., the current paths respectively through the transistors Q_{O1} to Q_{Ok}). The current mirror 338B receives a current-regulation signal (e.g., a current signal I_{ADJ}) through its reference path (e.g., including the transistor Q_{REF}) and generates driving currents I_{LED} through its output paths (e.g., respectively including the transistors Q_{O1} to Q_{Ok}), thereby regulating the maximum instantaneous value of the drive currents I_{LED} to a target value (e.g., proportional to the current-regulation signal I_{ADJ}). In some embodiments, the transistors Q_{O1} to Q_{Ok} can be referred to as current-regulation components. The light source driving device 206B can sense the voltages V_{IS1} to V_{ISk} at the current-regulation components Q_{O1} to Q_{Ok} (e.g., drain voltages of the MOSFETs Q_{O1} to Q_{Ok}) to determine the power supply status of the LEDs driven by the light source driving device 206B. In an embodiment, when the switch SW1 is turned on, the voltage drop across the switch SW1 is relatively small and can be ignored. Thus, the sensing voltage V_{IS1} can be considered to be a voltage at the current-regulation component Q_{O1}. Similarly, when the switches SW2 to SWk are turned on, the sensing voltages V_{IS2} to V_{ISk} can be considered to be voltages at the current-regulation component Q_{O2} to Q_{Ok}. The signals PWM1 to PWMk generated by the signal generation circuit 322 can turn on and off the switches SW1 to SWk, respectively. Therefore, the signal generation circuit 322 can adjust the average values of the driving currents I_{LED} by controlling the duty cycles of the signals PWM1 to PWMk, respectively. For example, the signal PWM1 controls the average value of the driving current I_{LED} through the switch SW1, the signal PWM2 controls the average value of the driving current I_{LED} through the switch SW2, and so on.

FIG. 4 illustrates a circuit diagram of examples of the comparator circuitry 318 and the power-supply adjustment module 320, in an embodiment of the present invention. FIG. 4 is described in combination with FIG. 2A, FIG. 2B, FIG. 2C, FIG. 3A, and FIG. 3B. In an embodiment, the comparator circuitry 318 includes comparators CMP₁ to CMPₖ and a logic circuit 426 (e.g., including an OR gate, NOR gate, NAND gate, or AND gate). The power-supply adjustment module 320 includes a feedback adjustment module 428 and a thermal reduction module 430.

In an embodiment, the comparators CMP1 to CMPk respectively compare the sensing voltages V_{IS1} to V_{ISk} with a preset voltage ADD_TH, and generate one or more of increment signals ADD1 to ADDk when one or more of the sensing voltages V_{IS1} to V_{ISk} are lower than the preset voltage ADD_TH. Any of the increment signals ADD1 to ADDk can cause the logic circuit 426 to generate a control signal S_{ADD} (e.g., also referred to as an “increment signal”). In response to receiving the increment signal S_{ADD}, the feedback adjustment module 428 can adjust (e.g., increase or decrease) the feedback output current I_{ADJFO} by a predetermined amount ΔI1. The thermal reduction module 430 can periodically generate a control signal S_{MINUS} (e.g., also referred to as a “decrement signal”) at a frequency F2. If no increment signal S_{ADD} is detected, the feedback adjustment module 428 can adjust (e.g., decrease or increase) the feedback output current I_{ADJFO} by a predetermined amount ΔI2 in response to receiving a decrement signal S_{MINUS}. If both the increment signal S_{ADD} and decrement signal S_{MINUS} are detected simultaneously, the feedback adjustment module 428 can ignore the decrement signal S_{MINUS}.

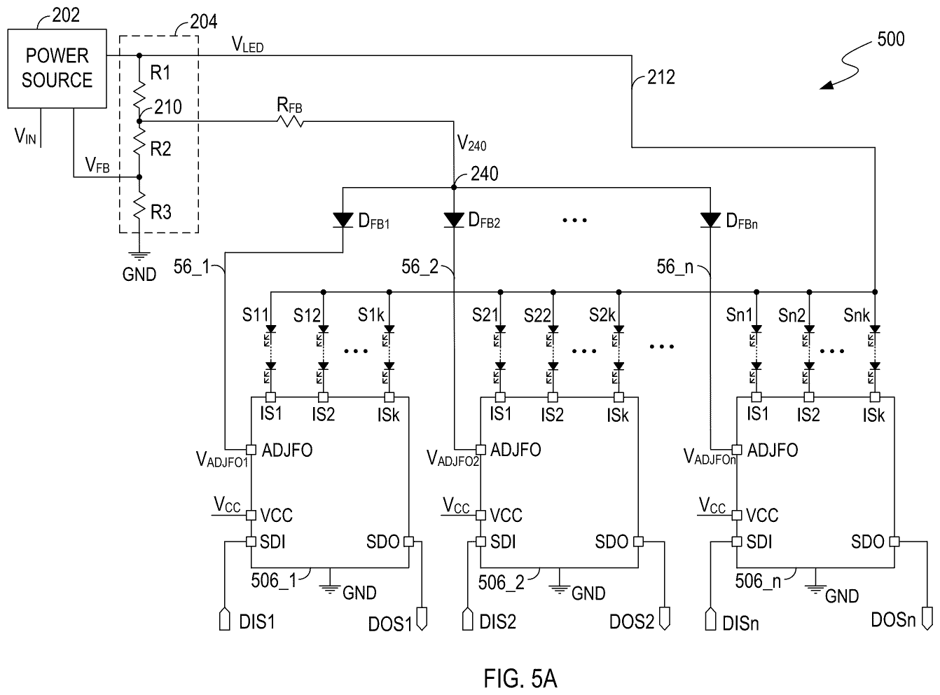

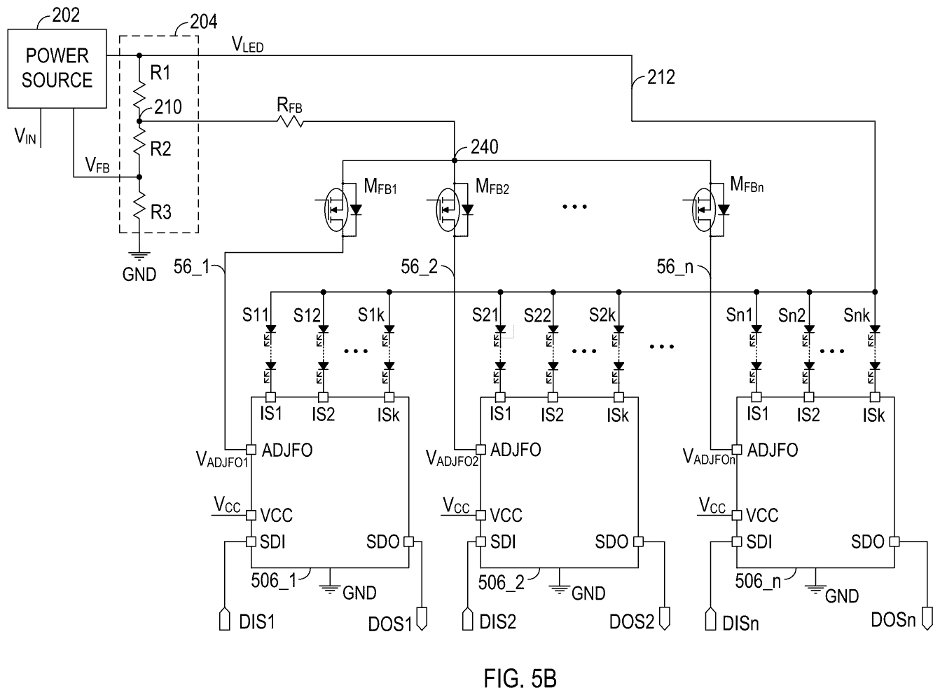

Although the feedback output signals 26_1 to 26_n in the abovementioned embodiments include currents, the invention is not so limited. In other embodiments, the feedback output signals can include voltages. FIG. 5A illustrates a block diagram of an example of a light source driving system 500, in another embodiment of the present invention. FIG. 5A is described in combination with FIG. 2A. The light source driving devices 506_1 to 506_n in FIG. 5A are similar to the devices 206_1 to 206_n in FIG. 2A, except that each of the feedback output signals 56_1 to 56_n generated by the light source driving devices 506_1 to 506_n includes a feedback output voltage V_{ADJFO1}, V_{ADJFO2}, . . . , or V_{ADJFOn}. The power-supply adjustment signal at the feedback node 240 includes a voltage V₂₄₀, which can be controlled by the minimum voltage of the feedback output signals 56_1 to 56_n.

As shown in FIG. 5A, the light source driving system 500 includes feedback diodes D_{FB1} to D_{FBn} respectively coupled between the light source driving devices 506_1 to 506_n and the feedback node 240. In an embodiment, the feedback diodes D_{FB1} to D_{FBn} can have the same forward voltage drop V_{FVD}. Thus, the combined circuit of the feedback diodes D_{FB1} to D_{FBn} can select a minimum signal from the feedback output signals 56_1 to 56_n to turn on a diode of the feedback diodes D_{FB1} to D_{FBn}, so that the minimum signal controls the power-supply adjustment voltage V₂₄₀ via the turned-on diode. For example, if the voltage V_{ADJFO1} is the minimum voltage among the feedback output voltages V_{ADJFO1} to V_{ADJFOn}, then the feedback diode D_{FB1} can be turned on, and the voltage at the feedback node 240 can be V_{FVD}+V_{ADJFO1}. Because the voltage V_{ADJFO1} is the minimum voltage among the feedback output voltages V_{ADJFO1} to V_{ADJFOn}, the voltage drops across the other feedback diodes D_{FB2} to D_{FBn} are less than their forward voltage drop V_{FVD}, and the feedback diodes D_{FB2} to D_{FBn} are turned off. Similarly, if both the voltages V_{ADJFO1} and V_{ADJFO2} have the minimum voltage among the feedback output voltages V_{ADJFO1} to V_{ADJFOn}, then the feedback diodes D_{FB1} and D_{FB2} are turned on. Therefore, the voltage level of the minimum signal among the feedback output signals 56_1 to 56_n controls the power-supply adjustment voltage V₂₄₀ at the feedback node 240. In an embodiment, the light source driving devices 506_1 to 506_n generate the feedback output voltages V_{ADJFO1} to V_{ADJFOn} in parallel (e.g., concurrently, and/or along side-by-side paths that meet at the feedback node 240), thereby controlling the power-supply adjustment voltage V₂₄₀ in parallel.

In an embodiment, the feedback circuit 204 generates a power-supply feedback signal V_{FB} based on the supply voltage V_{LED} and the power-supply adjustment voltage V₂₄₀. Similar to the embodiment of FIG. 2A, the power source 202 in FIG. 5A can adjust the power-supply feedback signal V_{FB} to a power-supply reference V_{REF}, thereby adjusting the supply voltage V_{LED} such that all the LEDs S11-S1k, S21-S2k, . . . , and Sn1-Snk are sufficiently powered. In the example of FIG. 5A, the feedback circuit 204 includes resistors R1, R2, and R3. The power-supply feedback signal V_{FB} can be given by: V_{FB}=V_{LED}*R3/(R1+R2+R3)−f(V₂₄₀), where f(V₂₄₀) represents a function of the power-supply adjustment voltage V₂₄₀. More specifically, in some embodiments, if the feedback diodes D_{FB1} to D_{FBn} are turned off, then f(V₂₄₀) is equal to zero. If one or more diodes of the feedback diodes D_{FB1} to D_{FBn} are turned on by the minimum voltage V_{ADJFO_MIN} of the feedback output voltages V_{ADJFO1} to V_{ADJFOn}, then f(V₂₄₀) can increase as the voltage V_{ADJFO_MIN} decreases, and decrease as the voltage V_{ADJFO_MIN} increases. Thus, if the voltage V_{ADJFO_MIN} decreases, the power-supply feedback signal V_{FB} can decrease, thereby increasing the supply voltage V_{LED}. If the voltage V_{ADJFO_MIN} increases, the power-supply feedback signal V_{FB} can increase, thereby decreasing the supply voltage V_{LED}.

In some embodiments, the feedback diodes D_{FB1} to D_{FBn} can be any type of diodes. For example, as shown in FIG. 5A, the feedback diodes D_{FB1} to D_{FBn} can be regular (conventional) diodes. For another example, as in FIG. 5B, the feedback diodes D_{FB1} to D_{FBn} can be body diodes of metal-oxide-semiconductor field-effect transistors (MOSFETs) M_{FB1} to M_{FBn}. In the example of FIG. 5B, when the MOSFETs M_{FB1} to M_{FBn} are turned off, the combined circuit of their body diodes can perform the minimum-voltage selection function, similar to the abovementioned combined circuit of the feedback diodes D_{FB1} to D_{FBn}. Additionally, in other possible embodiments, one of the MOSFETs M_{FB1} to M_{FBn} may be turned on to select a specific voltage from the feedback output voltages V_{ADJFO1} to V_{ADJFOn} to adjust the supply voltage V_{LED}.

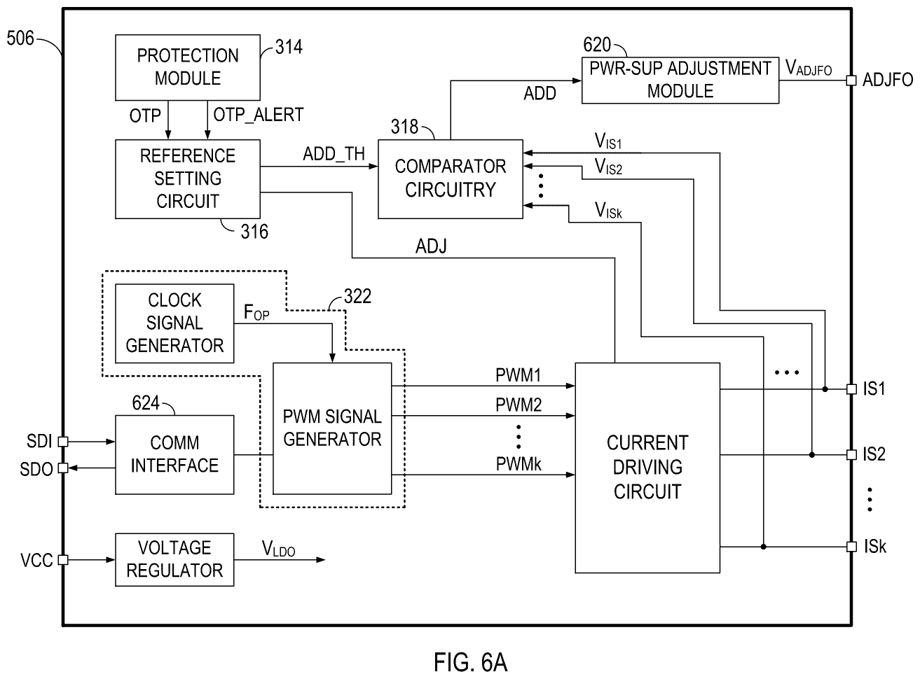

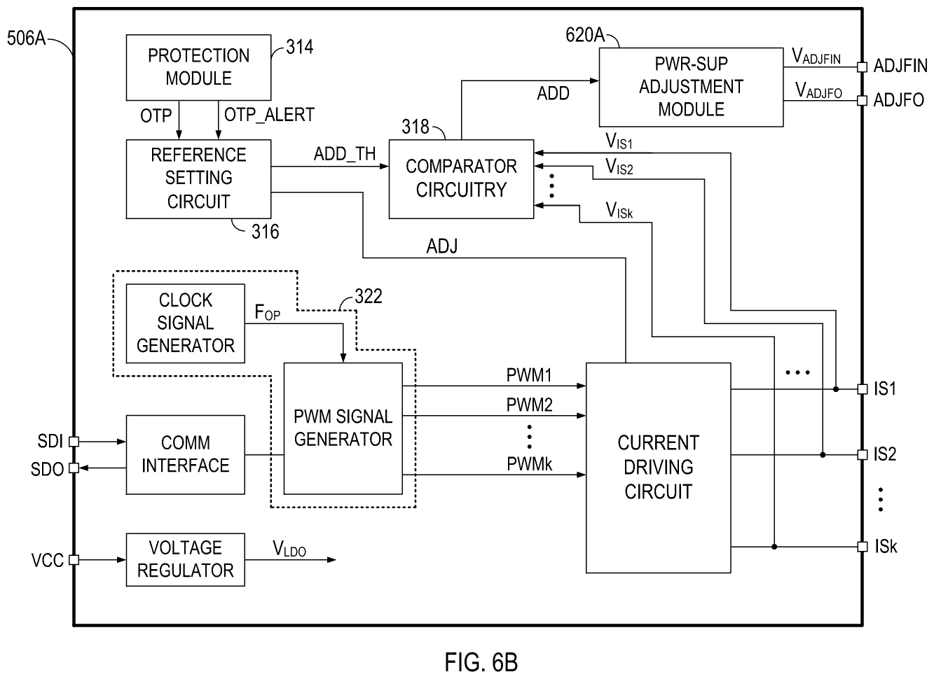

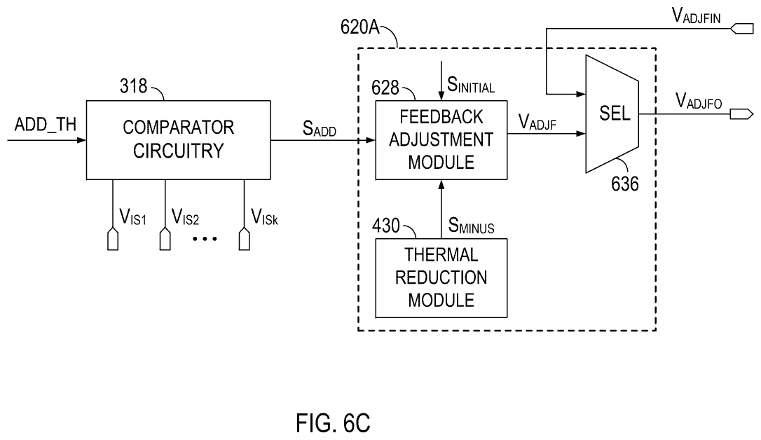

FIG. 6A illustrates a block diagram of an example of a light source driving device 506, in an embodiment of the present invention. The light source driving device 506 can be an embodiment of one of the aforementioned light source driving devices 506_1-506_n. FIG. 6A is described in combination with FIG. 3A, FIG. 3B, FIG. 4, FIG. 5A, and FIG. 5B. The device 506 in FIG. 6A can be similar to the device 206A in FIG. 3A or the device 206B in FIG. 3B, except that the feedback output signal generated by the power-supply adjustment module 620 in the device 506 includes a voltage V_{ADJFO}. The power-supply adjustment module 620 adjusts the feedback output voltage V_{ADJFO} according to the comparison result generated by the comparator circuitry 318, thereby adjusting the sensing voltages V_{IS1} to V_{ISk} to be greater than or equal to the preset voltage ADD_TH.

For example, similar to the comparator circuitry 318 and the power-supply adjustment module 320 in FIG. 3A and FIG. 3B, the comparator circuitry 318 in FIG. 6A can compare the sensing voltages V_{IS1} to V_{ISk} at the sensing terminals IS1-ISk with the preset voltage ADD_TH and provide a comparison result to the power-supply adjustment module 620. The comparator circuitry 318 can repeat the comparison operation at a specific frequency F1. Each time the comparator circuitry 318 detects that one or more of the sensing voltages V_{IS1} to V_{ISk} are less than the preset voltage ADD_TH, the comparator circuitry 318 generates an increment signal ADD (e.g., a digital signal “1” or “0”). If one or more of the sensing voltages V_{IS1} to V_{ISk} remain less than the preset voltage ADD_TH, then the comparator circuitry 318 can repeatedly generate the increment signal ADD. Each time the increment signal ADD is detected, the power-supply adjustment module 620 adjusts (e.g., reduces) the feedback output voltage V_{ADJFO} by a predetermined amount ΔV1 thereby controlling the power source 202 to increase the supply voltage V_{LED}. When all sensing voltages V_{IS1} to V_{ISk} are greater than or equal to the preset voltage ADD_TH, the comparator circuitry 318 stops generating the increment signal ADD. When no increment signal ADD is detected, the power-supply adjustment module 620 can repeatedly adjust (e.g., increase) the feedback output voltage V_{ADJFO} by a predetermined amount ΔV2 at a frequency F2 to reduce the supply voltage V_{LED} until the increment signal ADD is detected again. Thus, the power-supply adjustment module 620 can maintain the sensing voltages V_{IS1} to V_{ISk} around the preset voltage ADD_TH while reducing power consumption and lowering the temperature of the light source driving device 506.

FIG. 6B illustrates a block diagram of an example of a light source driving device 506A, in another embodiment of the present invention. The light source driving device 506A can be an embodiment of one of the aforementioned light source driving devices 506_1-506_n. FIG. 6B is described in combination with FIG. 3A, FIG. 3B, FIG. 4, FIG. 5A, FIG. 5B, and FIG. 6A. The device 506A in FIG. 6B is similar to the device 506 in FIG. 6A except that the device 506A includes a power-supply adjustment module 620A and a feedback input terminal ADJFIN. The power-supply adjustment module 620A can receive a feedback input voltage V_{ADJFIN} from an adjacent light source driving device (not shown in FIG. 6B) via the feedback input terminal ADJFIN. The feedback input voltage V_{ADJFIN} can indicate the power status of LEDs driven by the adjacent light source driving device. The power-supply adjustment module 620A can also generate an internal voltage (e.g., the voltage V_{ADJF} shown in FIG. 6C) based on the power status of LEDs driven by the light source driving device 506A. The power-supply adjustment module 620A can select the lower of the feedback input voltage V_{ADJFIN} and the internal voltage V_{ADJF}, and output it as a feedback output voltage V_{ADJFO} at the feedback output terminal ADJFO. The feedback output voltage V_{ADJFO} can indicate the power status of the LEDs driven by the light source driving device 506A and the adjacent light source driving device. In addition, the light source driving device 506A includes a signal input terminal SDI and signal output terminal SDO configured to input and output signals (e.g., including command signals, configuration information signals, data signals, etc.). More specifically, the signal terminals SDI and SDO can be serial communication terminals and configured to perform single-wire serial communication (e.g., 1-Wire Communication) with the abovementioned adjacent light source driving device. Therefore, the light source driving device 506A can perform single-wire serial communication with other light source driving devices through the signal terminals SDI and SDO, and transmit the information (e.g., including the power-supply adjustment signal I₂₄₀ or V₂₄₀) for the power status of the LEDs driven by those light source driving devices to the above-mentioned feedback circuit 204 through the signal terminals ADJFIN and ADJFO.

FIG. 6C illustrates a circuit diagram of examples of the comparator circuitry 318 and the power-supply adjustment module 620A, in an embodiment of the present invention. The adjustment module 620A in FIG. 6C is similar to the adjustment module 320 in FIG. 4, except that the adjustment module 620A includes a feedback adjustment module 628 and a selector circuit 636. The feedback adjustment module 628 generates an internal voltage V_{ADJF} according to an increment signal S_{ADD} provided by the comparator circuitry 318 and a decrement signal S_{MINUS} provided by the thermal reduction module 430. For example, the feedback adjustment module 628 can reduce the internal voltage V_{ADJF} by a predetermined amount ΔV1 when detecting an increment signal S_{ADD}. If no increment signal S_{ADD} is detected, the feedback adjustment module 628 can increase the internal voltage V_{ADJF} by a predetermined amount ΔV2 when detecting a decrement signal S_{MINUS}. If the feedback adjustment module 628 detects an increment signal S_{ADD} and a decrement signal S_{MINUS} at the same time, the feedback adjustment module 628 can ignore the decrement signal S_{MINUS}. The selector circuit 636 can select the lower of the feedback input voltage V_{ADJFIN} and the internal voltage V_{ADJF} as a feedback output voltage V_{ADJFO}.

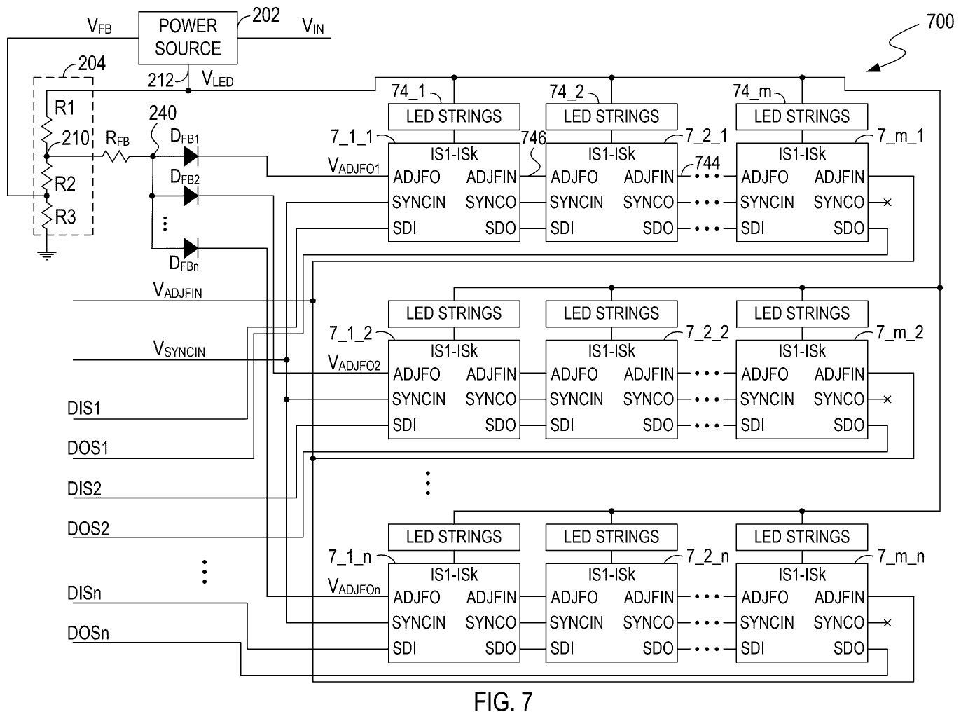

FIG. 7 illustrates a block diagram of an example of a light source driving system 700, in an embodiment of the present invention. FIG. 7 is described in combination with FIG. 5A, FIG. 6B, and FIG. 6C. As shown in FIG. 7, the light source driving system 700 includes multiple chains of light source driving devices 7_1_1 to 7_m_1, 7_1_2 to 7_m_2, . . . , and 7_1_n to 7_m_n, where “m” and “n” are natural numbers. In other words, the multiple chains of light source driving devices include n device chains, and each device chain includes m devices. In an embodiment, each device (hereinafter, device 7) of the devices 7_1_1 to 7_m_1, 7_1_2 to 7_m_2, . . . , and 7_1_n to 7_m_n is similar to the aforementioned light source driving device 506_1 to 506_n, except that the device 7 further includes a synchronization input terminal SYNCIN, a synchronization output terminal SYNCO, and a feedback input terminal ADJFIN. Additionally, the signal input terminal SDI and signal output terminal SDO of the device 7 can be used for single-wire serial communication (1-Wire Communication). Therefore, the light source driving devices 7_1_1 to 7_m_1 can communicate with each other through their SDI and SDO terminals; the light source driving devices 7_1_2 to 7_m_2 can communicate with each other through their SDI and SDO terminals; and so on. In some embodiments, the device 7 can include the circuit structure of the light source driving device 506A shown in FIG. 6B.

As shown in FIG. 7, the light source driving system 700 can drive multiple sets of LED strings sharing a common power supply terminal 212. Each device 7 can drive a respective set of LED strings. For example, the device 7_1_1 can drive LED strings 74_1, the device 7_2_1 can drive LED strings 74_2, and so on. The device chains 7_1_1 to 7_m_1, 7_1_2 to 7_m_2, . . . , and 7_1_n to 7_m_n are coupled to a feedback node 240 via feedback diodes D_{FB1} to D_{FBn}, respectively. Each device chain includes a primary device and multiple secondary devices. The secondary devices can perform serial communication with the primary device. For example, the device chain 7_1_1 to 7_m_1 includes a primary device 7_1_1 and secondary devices 7_2_1 to 7_m_1, and the secondary devices 7_2_1 to 7_m_1 can communicate serially with the primary device 7_1_1; the device chain 7_1_2 to 7_m_2 includes a primary device 7_1_2 and secondary devices 7_2_2 to 7_m_2, and the secondary devices 7_2_2 to 7_m_2 can communicate serially with the primary device 7_1_2; and so on.

In an embodiment, the primary device in each device chain can output a feedback output signal (e.g., V_{ADJFO1}, V_{ADJFO2}, . . . , or V_{ADJFOn} shown in FIG. 7) at its feedback output terminal ADJFO to indicate the power supply status of the multiple sets of LED strings driven by the device chain. The feedback diodes D_{FB1} to D_{FBn} can select a minimum voltage V_{ADJFO_MIN} from the feedback output voltages V_{ADJFO1} to V_{ADJFOn} and generate a power-supply adjustment voltage V₂₄₀ at the feedback node 240, e.g., V₂₄₀=V_{FVD}+V_{ADJFO_MIN}, where V_{FVD} represents the forward voltage drop of the feedback diodes D_{FB1} to D_{FBn}. The power source 202 adjusts the supply voltage V_{LED} based on the power-supply adjustment voltage V₂₄₀ to ensure sufficient power supply for all LED strings driven by the light source driving system 700.

Taking FIG. 7 for example, in the device chain 7_1_1 to 7_m_1, a first secondary device 7_2_1 is adjacently coupled to the primary device 7_1_1, and a second secondary device 7_3_1 (not explicitly shown in FIG. 7) is adjacently to the first secondary device 7_2_1. The feedback input terminal ADJFIN of the first secondary device 7_2_1 can receive a feedback input voltage 744 from the feedback output terminal ADJFO of the second secondary device 7_3_1. The feedback input voltage 744 can indicate the power supply status of the LED strings 74_3 to 74_m driven by the secondary devices 7_3_1 to 7_m_1. The feedback output terminal ADJFO of the first secondary device 7_2_1 provides a feedback output voltage 746 to the primary device 7_1_1 (also referred to as the primary light source driving device). The first secondary device 7_2_1 can include a power-supply adjustment module (e.g., the module 620A shown in FIG. 6B) configured to generate a first internal voltage (e.g., similar to the voltage V_{ADJF} in FIG. 6C) based on the power supply status of the LED strings 74_2 driven by the first secondary device 7_2_1, and select the lower of the first internal voltage V_{ADJF} and the feedback input signal 744 (e.g., a voltage signal) as the feedback output signal 746. Thus, the feedback output signal 746 can indicate the power supply status of the LED strings 74_2 to 74_m. Similarly, the primary light source driving device 7_1_1 can generate a second internal voltage (e.g., similar to the voltage V_{ADJF} in FIG. 6C) based on the power supply status of the LED strings 74_1 it drives, and select the lower of the second internal voltage V_{ADJF} and the feedback output signal 746 (e.g., a voltage signal) received from the first secondary device 7_2_1 as a feedback output voltage V_{ADJFO1}. Therefore, the feedback output voltage V_{ADJFO1} can indicate the power supply status of the LED strings 74_1 to 74_m. Likewise, the feedback output voltage V_{ADJFO2} can indicate the power supply status of the LED strings driven by the devices 7_1_2 to 7_m_2, and so on. The feedback diodes D_{FB1} to D_{FBn} select the lowest voltage V_{ADJFO_MIN} from the feedback output voltages V_{ADJFO1} to V_{ADJFOn}. The selected feedback output voltage V_{ADJFO_MIN} can indicate the power supply status of the LED strings driven by the system 700 (e.g., whether there is one or more LED strings is in the power-increasable state). Thus, the power source 702 can adjust the supply voltage V_{LED} for all LED strings in FIG. 7 based on the feedback output voltage V_{ADJFO_MIN} to ensure sufficient power supply for all the LED strings.

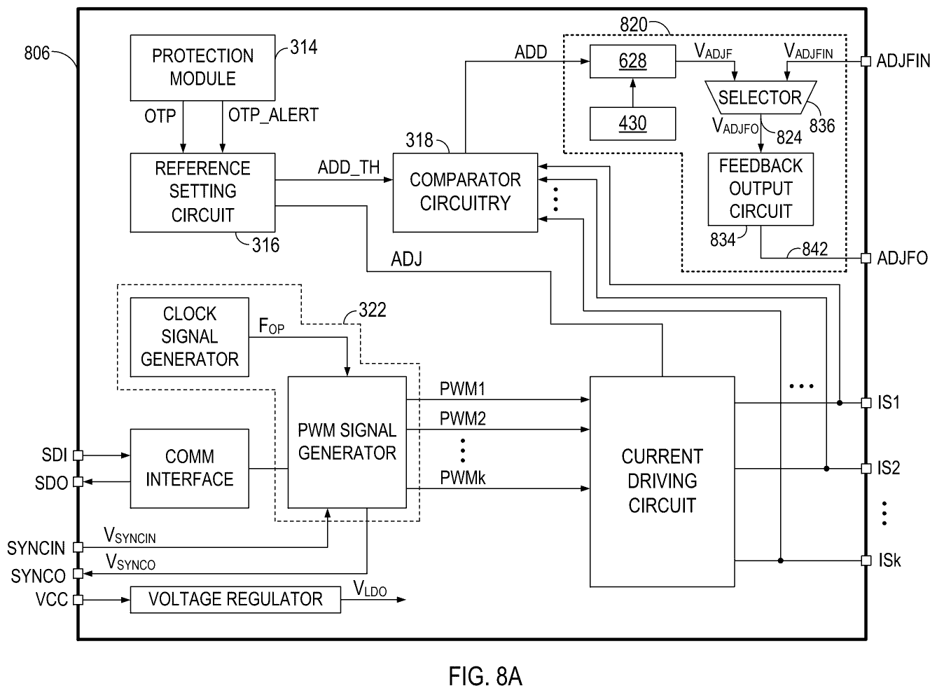

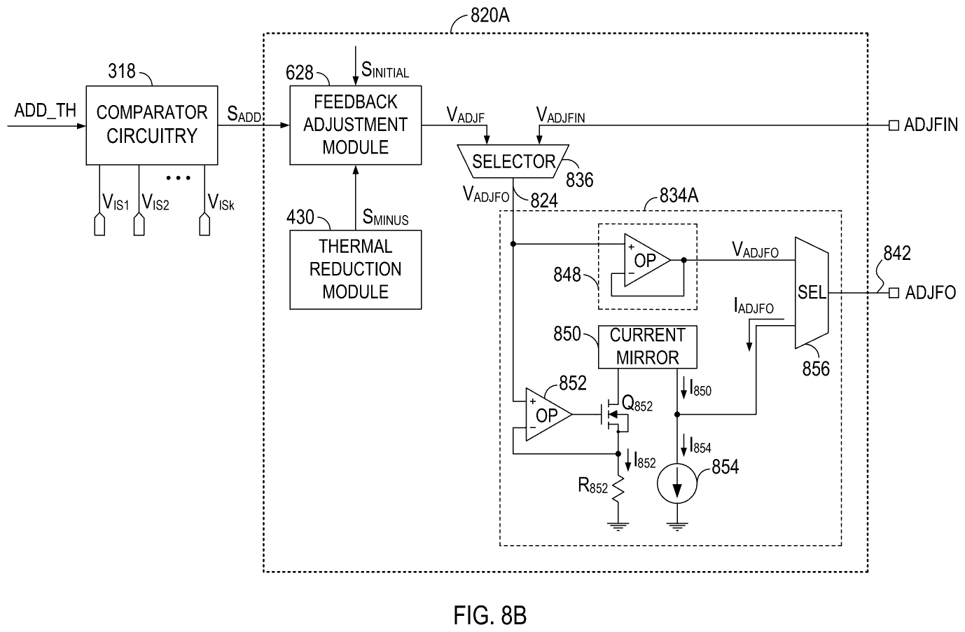

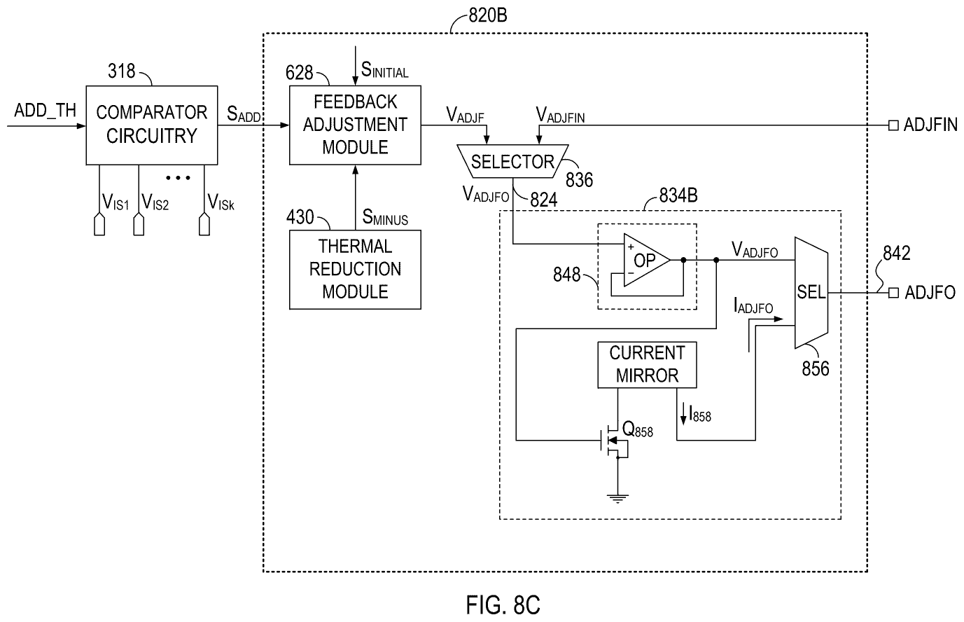

FIG. 8A illustrates a block diagram of an example of a light source driving device 806, in another embodiment of the present invention. FIG. 8A is described in combination with FIG. 6B. The device 806 in FIG. 8A is similar to the device 506A in FIG. 6B except that the device 806 supports a voltage feedback mode and a current feedback mode. More specifically, the power-supply adjustment module 820 in the device 806 includes a feedback adjustment module 628, a thermal reduction module 430, a selector 836, and a feedback output circuit 834. The output signal 842 of the feedback output circuit 834 can be set to be a voltage or a current based on the application condition of the light source driving device 806.

For example, the application condition includes a first condition and a second condition. If the feedback output terminal ADJFO of the light source driving device 806 is coupled to an adjacent light source driving device and configured to provide the feedback output signal 842 to the feedback input terminal ADJFIN of the adjacent light source driving device, then the light source driving device 806 is in the first condition. In the first condition, the power-supply adjustment module 820 is configured to operate in the voltage feedback mode. In the voltage feedback mode, the feedback output signal 842 includes a feedback output voltage. If the feedback output terminal ADJFO of the light source driving device 806 is coupled to the feedback circuit 204 and configured to provide the feedback output signal 842 to the feedback circuit 204 for controlling the supply voltage V_{LED}, then the light source driving device 806 is in the second condition. In the second condition, the power-supply adjustment module 820 is configured to operate in the current feedback mode. In the current feedback mode, the feedback output signal 842 includes a feedback output current. In some embodiments, the light source driving device 806 can receive configuration information through the signal input terminal SDI and set the power-supply adjustment module 820 to operate in the voltage feedback mode or the current feedback mode based on the configuration information.

FIG. 8B illustrates a circuit diagram of examples of comparator circuitry 318 and a power-supply adjustment module 820A, in an embodiment of the present invention. FIG. 8B is described in combination with FIG. 6C and FIG. 8A. The power-supply adjustment module 820A in FIG. 8B can be an embodiment of the power-supply adjustment module 820 in FIG. 8A. Operations of the comparator circuitry 318, feedback adjustment module 628, thermal reduction module 430, and selector 836 in FIG. 8B are similar to those of the aforementioned comparator circuitry 318, feedback adjustment module 628, thermal reduction module 430, and selector circuit 636 in FIG. 6C except that the feedback voltage 824 generated by the selector 836 is provided to the feedback output circuit 834A. More specifically, the selector 836 can receive a feedback voltage V_{ADJFIN} from the feedback input terminal ADJFIN and an internal voltage V_{ADJF} from the feedback adjustment module 628, and select the lower of the voltages V_{ADJFIN} and V_{ADJF} as a feedback voltage 824. The feedback output circuit 834A generates a feedback output signal 842 based on the feedback voltage 824.

For example, as shown in FIG. 8B, the feedback output circuit 834A includes a selector 856 and two paths coupled between the selector 856 and the selector 836. One path (e.g., referred to as the first path) includes a voltage follower 848. The other path (e.g., referred to as the second path) includes a current mirror 850, a voltage-to-current conversion circuit (hereinafter, V/C circuit) coupled to a first branch of the current mirror 850, and a sink current source 854 coupled to a second branch of the current mirror 850. The V/C circuit can include an operational amplifier 852, a transistor Q₈₅₂, and a resistor R₈₅₂. The sink current source 854 generates a sink current I₈₅₄. In the first path, the voltage follower 848 provides the value of the feedback voltage 824 (e.g., represented by V_{ADJFO}) to the selector 856. In the second path, the V/C circuit converts the feedback voltage V_{ADJFO} into a first current I₈₅₂ (where the first current I₈₅₂ is proportional to the voltage V_{ADJFO}), and the current mirror 850 generates a second current I₈₅₀ flowing into the sink current source 854 based on the first current I₈₅₂ (where the second current I₈₅₀ is proportional to the first current I₈₅₂). The selector 856 can allow a feedback current I_{ADJFO} to flow through the second path, where I_{ADJFO}=I₈₅₄−I₈₅₀. In the example of FIG. 8B, the feedback current I_{ADJFO} can flow into the power-supply adjustment module 820A as a sink current, and its current value is inversely proportional to the voltage value V_{ADJFO}. If the power-supply adjustment module 820A operates in the voltage feedback mode, the selector 856 selects the voltage V_{ADJFO} as the feedback output signal 842. If the power-supply adjustment module 820A operates in the current feedback mode, the selector 856 selects the sink current I_{ADJFO} as the feedback output signal 842.

FIG. 8C illustrates a circuit diagram of examples of the comparator circuitry 318 and a power-supply adjustment module 820B, in another embodiment of the present invention. FIG. 8C is described in combination with FIG. 6C, FIG. 8A, and FIG. 8B. The power-supply adjustment module 820B in FIG. 8C can be an embodiment of the power-supply adjustment module 820 in FIG. 8A. The power-supply adjustment module 820B in FIG. 8C is similar to the power-supply adjustment module 820A in FIG. 8A except that the feedback current I_{ADJFO} generated in the second path of the feedback output circuit 834B is a source current that flows out from the power-supply adjustment module 820B, and its current value is proportional to the voltage value V_{ADJFO}.

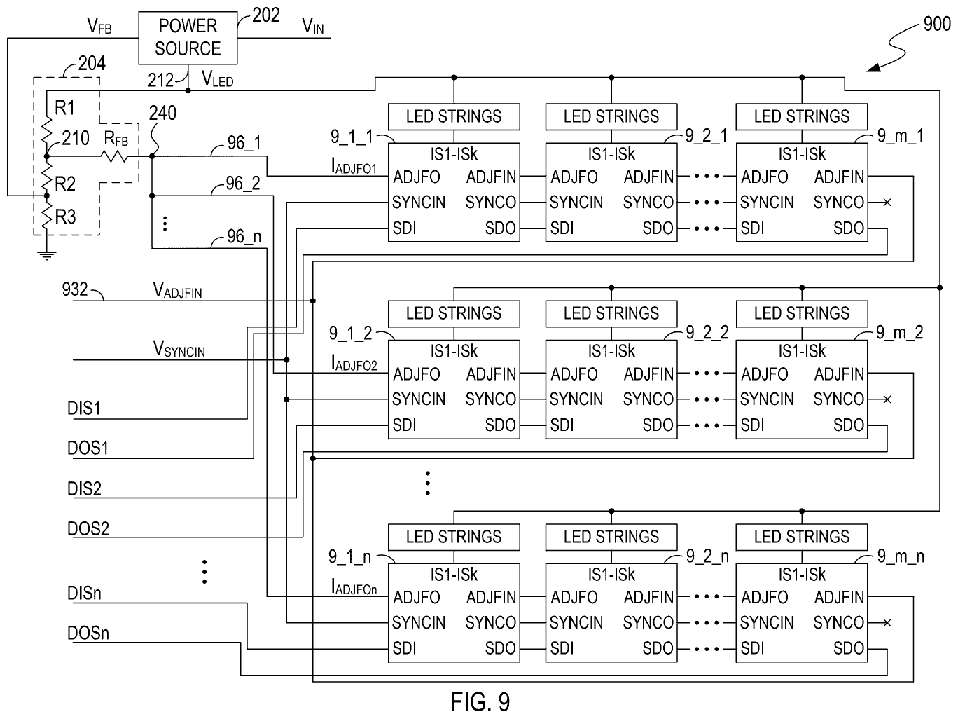

FIG. 9 illustrates a block diagram of an example of a light source driving system 900, in an embodiment of the present invention. FIG. 9 is described in combination with FIG. 7, FIG. 8A, FIG. 8B, and FIG. 8C. The system 900 in FIG. 9 can be similar to the system 700 in FIG. 7 except that, in the system 900, the light source driving devices 9_1_1 to 9_m_1, 9_1_2 to 9_m_2, . . . , and 9_1_n to 9_m_n can be configured to operate in a voltage feedback mode or a current feedback mode depending on their respective application conditions. The light source driving device 806 in FIG. 8A can be an embodiment of one of the light source driving devices 9_1_1 to 9_m_1, 9_1_2 to 9_m_2, . . . , and 9_1_n to 9_m_n in FIG. 9.

For example, in some embodiments, compared to transmission circuits that transmit current, voltage transmission circuits are simpler in design and have lower cost and power consumption. Therefore, the secondary devices 9_2_1 to 9_m_1 can be configured to operate in the voltage feedback mode, in which the secondary devices 9_2_1 to 9_m_1 generate respective feedback output voltages V_{ADJFO} and transmit the power supply status information of the LEDs, driven by the secondary devices 9_2_1 to 9_m_1, to the primary device 9_1_1 using their feedback output voltages V_{ADJFO}. Similarly, the secondary devices 9_2_2 to 9_m_2 can also be configured to operate in the voltage feedback mode, and so on. Additionally, in some embodiments, compared to parallel voltage control, parallel current control offers faster response speed and higher control efficiency. Therefore, the primary devices 9_1_1, 9_1_2, . . . , and 9_1_n can be configured to operate in the current feedback mode, in which the primary devices 9_1_1 to 9_1_n generate respective feedback output currents I_{ADJFO1} to I_{ADJFOn} to control the power-supply adjustment current I₂₄₀ at the feedback node 240 in parallel.

Accordingly, compared to conventional light source driving systems, light source driving systems (e.g., 700 and 900) in embodiments of the present invention can eliminate the need for multiple controllers to monitor multiple chains of light source driving devices (e.g., thereby reducing cost and power consumption) while enabling fast and effective control of the power supply voltages for LEDs.

While the foregoing description and drawings represent embodiments of the present invention, it will be understood that various additions, modifications, and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A light source driving system operable for driving a plurality of sets of LEDs sharing a common power supply terminal, said light source driving system comprising:
a feedback node configured to provide a power-supply adjustment signal to adjust a supply voltage at said power supply terminal; and
a plurality of light source driving devices, coupled to said feedback node, and configured to generate a plurality of feedback output signals to control said power-supply adjustment signal in parallel, wherein each light source driving device of said plurality of light source driving devices is configured to drive a set of LEDs of said plurality of sets of LEDs, and to generate a feedback output signal of said plurality of feedback output signals based on a power supply status of said set of LEDs.

2. The light source driving system of claim 1, further comprising:
a feedback circuit, coupled to said power supply terminal and said feedback node, and configured to generate a power-supply feedback signal based on said supply voltage and said power-supply adjustment signal; and
a power source, coupled to said feedback circuit, and configured to receive said power-supply feedback signal and generate said supply voltage at said power supply terminal, wherein said power source is configured to regulate said power-supply feedback signal to a power-supply reference, thereby adjusting said supply voltage such that said plurality of sets of LEDs operate in a power-sufficient state.

3. The light source driving system of claim 1, wherein each feedback output signal of said plurality of feedback output signals comprises a feedback output voltage, and wherein said power-supply adjustment signal is controlled by a minimum voltage of said plurality of feedback output signals.

4. The light source driving system of claim 3, further comprising:
a plurality of feedback diodes, coupled between said plurality of light source driving devices and said feedback node respectively, and configured to select a minimum signal from said plurality of feedback output signals to turn on a diode of said plurality of feedback diodes, so that said minimum signal controls said power-supply adjustment signal via said diode.

5. The light source driving system of claim 1, wherein each feedback output of said plurality of feedback output signals comprises a feedback output current flowing through said feedback node, and wherein said power-supply adjustment signal is controlled by a sum of current values of said plurality of feedback output signals.

6. The light source driving system of claim 5, wherein said feedback output current comprises a sink current flowing into a corresponding light source driving device of said plurality of light source driving devices.

7. The light source driving system of claim 5, wherein said feedback output current comprises a source current flowing out from a corresponding light source driving device of said plurality of light source driving devices.

8. The light source driving system of claim 1, wherein said power supply status comprises a power-sufficient state and a power-increasable state, wherein a first light source driving device of said plurality of light source driving devices is configured to drive a first set of LEDs of said plurality of sets of LEDs and to sense a sensing voltage at a current-regulation component coupled between said first set of LEDs and a reference ground; wherein when said sensing voltage is greater than a preset voltage, said first set of LEDs is in said power-sufficient state; and wherein when said sensing voltage is less than said preset voltage, said first set of LEDs is in said power-increasable state.

9. The light source driving system of claim 8, wherein said first light source driving device comprises:
comparator circuitry, coupled to said current-regulating component, and configured to compare said sensing voltage with said preset voltage to generate a comparison result; and
a power-supply adjustment module, coupled to said comparator circuitry, and configured to adjust the feedback output signal of said first light source driving device according to said comparison result, thereby adjusting said sensing voltage to be greater than or equal to said preset voltage.

10. The light source driving system of claim 9, wherein said first light source driving device further comprises:
a reference setting circuit, coupled to said comparator circuitry, and configured to generate said preset voltage, and generate a current-regulation signal to regulate a maximum instantaneous value of a driving current of said first set of LEDs; and
a protection module, coupled to said reference setting circuit, and configured to monitor a temperature of said first light source driving device; wherein when said temperature is greater than a first temperature threshold, said reference setting circuit reduces said preset voltage and said current-regulation signal to reduce said temperature, and when said temperature is reduced to a second temperature threshold, said reference setting circuit maintains said preset voltage and said current-regulation signal unchanged; and wherein said second temperature threshold is less than said first temperature threshold.

11. The light source driving system of claim 1, further comprising:
a plurality of chains of secondary devices, each chain of said plurality of chains comprising a plurality of secondary devices configured to perform serial communication with a corresponding light source driving device of said plurality of light source driving devices, wherein a first secondary device of said plurality of secondary devices, adjacently coupled to said corresponding light source driving device, is configured to drive a first set of LEDs of said plurality of sets of LEDs, and wherein said first secondary device comprises:
a feedback input terminal configured to receive a feedback input voltage from a second secondary device of said plurality of secondary devices that is adjacently coupled to said first secondary device;
a feedback output terminal configured to provide a feedback output voltage to said corresponding light source driving device;
a sensing terminal configured to sense a power supply status of said first set of LEDs; and
a power-supply adjustment module, coupled to said feedback input terminal, said feedback output terminal, and said sensing terminal, and configured to generate a first internal voltage based on said power supply status of said first set of LEDs, and select said feedback output voltage from said first internal voltage and said feedback input voltage.

12. The light source driving system of claim 11, wherein said corresponding light source driving device is configured to generate a second internal voltage according to a power supply status of a set of LEDs driven by said corresponding light source driving device, and to select a voltage from said second internal voltage and said feedback output voltage received from said first secondary device to control the feedback output signal of said corresponding light source driving device.

13. A light source driving device comprising:
a sensing terminal configured to sense a power supply status of a first set of LEDs driven by said light source driving device, wherein said power supply status of said first set of LEDs comprises a power-sufficient state and a power-increasable state;
a serial communication terminal configured to communicate serially with a first adjacent driving device;
a feedback input terminal configured to receive a feedback input voltage from said first adjacent driving device, wherein said feedback input voltage indicates a power supply status of a second set of LEDs driven by said first adjacent driving device;
a feedback output terminal configured to provide a feedback output signal to adjust a supply voltage of said first set of LEDs and said second set of LEDs; and
a control circuit, coupled to said feedback input terminal and said feedback output terminal, and configured to generate an internal voltage according to said power supply status of said first set of LEDs, select a feedback voltage from said internal voltage and said feedback input voltage, and to generate said feedback output signal according to said feedback voltage, wherein said control circuit is also configured to operate in a mode of a voltage feedback mode and a current feedback mode based on an application condition of said light source driving device, wherein in said voltage feedback mode, said feedback output signal comprises a feedback output voltage controlled by said feedback voltage, and wherein in said current feedback mode, said feedback output signal comprises a feedback output current controlled by said feedback voltage.

14. The light source driving device of claim 13, wherein said application condition comprises a first condition and a second condition, wherein if said feedback output terminal provides said feedback output signal to a feedback input terminal of a second adjacent driving device, said light source driving device is in said first condition, and said control circuit operates in said voltage feedback mode; and if said feedback output terminal provides said feedback output signal to a feedback circuit for controlling said supply voltage, said light source driving device is in said second condition, and said control circuit operates in said current feedback mode.

15. The light source driving device of claim 13, wherein said sensing terminal is coupled to a reference ground through a current-regulation component that controls a current flowing through said first set of LEDs and said sensing terminal; wherein when a voltage at said sensing terminal is greater than a preset voltage, said first set of LEDs is in said power-sufficient state; and wherein when said voltage at said sensing terminal is less than said preset voltage, said first set of LEDs is in said power-increasable state.

16. The light source driving device of claim 13, wherein said control circuit comprises:
comparator circuitry, coupled to said sensing terminal, and configured to compare said voltage at said sensing terminal with said preset voltage to generate a comparison result; and
a power-supply adjustment module, coupled to said comparator circuitry, said feedback input terminal, and said feedback output terminal, and configured to generate said internal voltage according to said comparison result, thereby adjusting said voltage at said sensing terminal to be greater than or equal to said preset voltage.

17. The light source driving device of claim 16, wherein said control circuit further comprises:
a reference setting circuit, coupled to said comparator circuitry, and configured to generate said preset voltage, and to generate a current-regulation signal to regulate a maximum instantaneous value of a driving current of said first set of LEDs; and
a protection module, coupled to said reference setting circuit, and configured to monitor a temperature of said light source driving device; wherein when said temperature is greater than a first temperature threshold, said reference setting circuit reduces said preset voltage and said current-regulation signal to reduce said temperature, and when said temperature is reduced to a second temperature threshold, said reference setting circuit maintains said preset voltage and said current-regulation signal unchanged; and wherein said second temperature threshold is less than said first temperature threshold.
